(19) United States
(12) Patent Application Publication
(10) Pub. No.: US 2009/0246510 A1
(43) Pub. Date: Oct. 1, 2009

(54) METALLIC NANOCRYSTAL PATTERNING

(75) Inventors: Joel Dufourcq, Grenoble (FR); Laurent Vandroux, Le Cheylas (FR); Pierre Mur, Crolles (FR); Sylvie Bodnar, Trets (FR)

Correspondence Address: SCHWEGMAN, LUNDBERG & WOESSNER, P.A., P.O. BOX 2938, MINNEAPOLIS, MN, 55402, US

(73) Assignees: COMMISSARIAT A L'ENERGIE ATOMIQUE, PARIS (FR); ATMEL ROUSSET, PARIS (FR)

(21) Appl. No.: 12/055,273

(22) Filed: Mar. 25, 2008

(51) Int. Cl. B32B 5/16; B44C 1/22

(52) U.S. Cl. 428/328; 216/40

(57) ABSTRACT

A device and method include forming a mask on a substrate supporting a plurality of metallic nanocrystals such that a portion of the metallic nanocrystals is exposed. Protective shells are formed about the exposed metallic nanocrystals. Unprotected metallic nanocrystals are removed.

### CROSS REFERENCE TO RELATED APPLICATION

This application is related to U.S. application Ser. No. ______, entitled “METALLIC NANOCRYSTAL ENCAPSULATION” (Attorney Docket No. 2800.004US1), filed ______, which application is incorporated herein by reference.

### BACKGROUND

Non-volatile nanocrystal transistor memory cells use a transistor floating gate as a charge storage region, transferring charge through a tunneling barrier to nanocrystals. The electrostatic properties of a nanocrystal layer are modified, influencing a subsurface channel between source and drain in a MOS transistor to represent various logical values.

### BRIEF DESCRIPTION OF THE DRAWINGS

FIG. 1 is a perspective block diagram of a device illustrating formation or elaboration of metallic nanocrystals according to an example embodiment.

FIG. 2 is a perspective block diagram of the device of FIG. 1 illustrating a mask over the metallic nanocrystals according to an example embodiment.

FIG. 3 is a side cross-section representation of an exposed metallic nanocrystal according to an example embodiment.

FIG. 4 is a side cross-section representation of a silanized exposed metallic nanocrystal according to an example embodiment.

FIG. 5 is a perspective block diagram of a device illustrating patterned metallic nanocrystals according to an example embodiment.

FIG. 6 is a side cross-section representation of a metallic nanocrystal having a protective oxide shell according to an example embodiment.

FIG. 7 is a perspective block diagram of a device illustrating patterned metallic nanocrystals without unprotected metallic nanocrystals according to an example embodiment.

FIG. 8 is a block cross-section representation of a memory device having patterned metallic nanocrystals according to an example embodiment.

### DETAILED DESCRIPTION

In the following description, reference is made to the accompanying drawings that form a part hereof, and in which is shown by way of illustration specific embodiments, which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Metallic nanocrystals, (also referred to as nanoparticles or dots) are used in various embodiments to replace silicon nanocrystals in nanocrystal floating gate memories. Localizing metallic dots to form floating gates is difficult. To solve this problem, various methods and resulting devices utilizing masks and forming protective shells are used to create patterned nanocrystal device for use in floating gate memories and other devices.

In one embodiment a mask is formed on a substrate supporting a plurality of metallic nanocrystals such that a portion of the metallic nanocrystals are exposed to a silicon precursor as described in co-pending U.S. patent application entitled “Metallic Nanocrystal Encapsulation” having docket number 2800.004US1, and filed on the same date herewith. Protective shells are formed about the exposed metallic nanocrystals. The unprotected metallic nanocrystals are removed, leaving a patterned plurality of metallic nanocrystals that in one embodiment may form a charge storage region for a floating gate memory device.

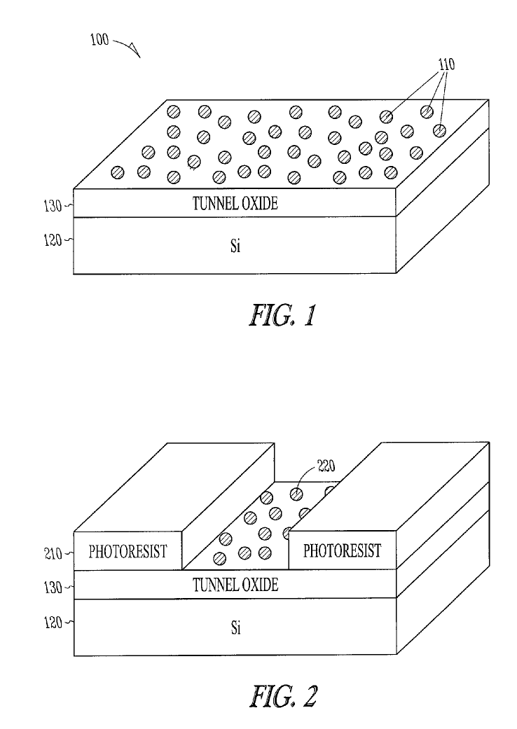

FIG. 1 is a perspective block diagram of a device 100 illustrating formation or elaboration of metallic nanocrystals 110 supported by a substrate 120. Reference number 110 points to only a few of the nanocrystals to simplify the drawing. In one embodiment, the metallic nanocrystals 110 are formed on an oxide layer 130 supported by the substrate 120. Many different methods may be used to form the metallic nanocrystals 110, such as the use of physical vapor deposition of a thin metal layer, followed by a rapid thermal annealing in the 50-1000° C. temperature range. In some embodiments, rapid thermal annealing may be performed in the 200-1000° C. range in the case of Pt and Ni on oxide. In one embodiment, annealing the metallic layer results in the formation of metallic dots which form the metallic nanocrystals 110. Metallic nanocrystals 110 are dispersed about the surface of oxide layer 130 such that they are physically separated from each other. In one embodiment, the metallic nanocrystals 110 are fairly uniformly distributed about the surface of the oxide layer 130 with a density in the 10¹⁰-10¹⁴/cm² range and diameter ranging between 2 and 20 nm in various embodiments. The metallic nanocrystal 110 diameter is a function of the annealing time and initial layer thickness. For example, with Pt, the density may be 10¹²/cm² and the diameter in the 2-10 nm range in some embodiments. These parameters may be varied significantly in further embodiments.

In one embodiment, the metallic nanocrystals 110 include a metal nobler than silicon according to Ellingham diagrams, which are plots of the free energy of formation of a metal oxide per mole of oxygen (O₂) against temperature. Some example metals include but are not limited to Ni, Pt, Ag, and W. Further metals may include Ag and Au.

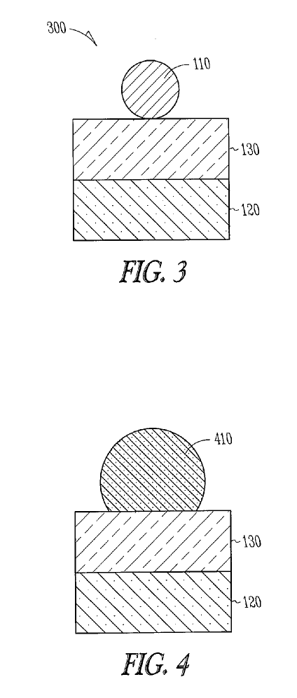

FIG. 2 shows device 100 from FIG. 1, and further includes a patterned mask 210, such as a photo resist, or any other type of patternable material that may be selectively removed. Mask 210 covers some of the metallic nanocrystals 110, but leaves other exposed as indicated at 220. A side view of an exposed metallic nanocrystal 110 is shown in cross section 300 in FIG. 3.

The exposed 220 metallic nanocrystals 110 are then exposed to a silicon precursor gas, such as SiH₄, Si₂H₆, etc., at a low temperature, such as less than approximately 450° C. This creates a layer of silicon 410 covering the exposed metallic nanocrystals 110 in FIG. 4. This may also be referred to as silanization of the metallic nanocrystals. In one embodiment, the silicon layer is thick enough to protect the metallic nanocrystals from further selected processing steps. One approach of determining a proper thickness after silanization involves exposing the metallic nanocrystals 110 having a silicon layer 410 to an oxidant annealing (for example 20% O₂ in nitrogen) and observing with MEB that there is no coalescence of the metallic nanocrystals 110.

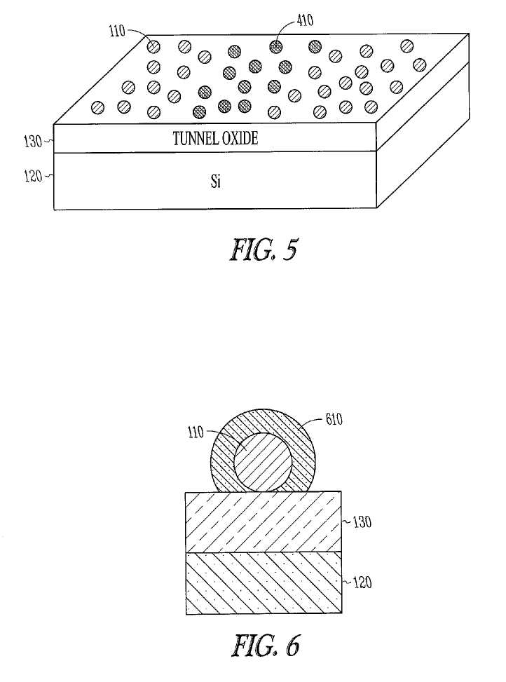

Resist 210 is then removed to expose at oxidizing ambiance the previously covered metallic nanocrystals 110 as illustrated in FIG. 5. The metallic nanocrystals 110 having a silicon layer 410 are also shown in FIG. 5. During or after the process of removing or stripping the resist, the silanized metallic nanocrystals 110 having a layer of silicon 410 may be exposed to an oxidizing environment, resulting in oxidation of the silicon layer 410 resulting in a SiO₂ protective shell 610 in FIG. 6. The protective shell is thick enough to protect the metallic nanocrystal 110. The forming of the protective shell 610 may also be referred to as passivation of the metallic nanocrystals 110.

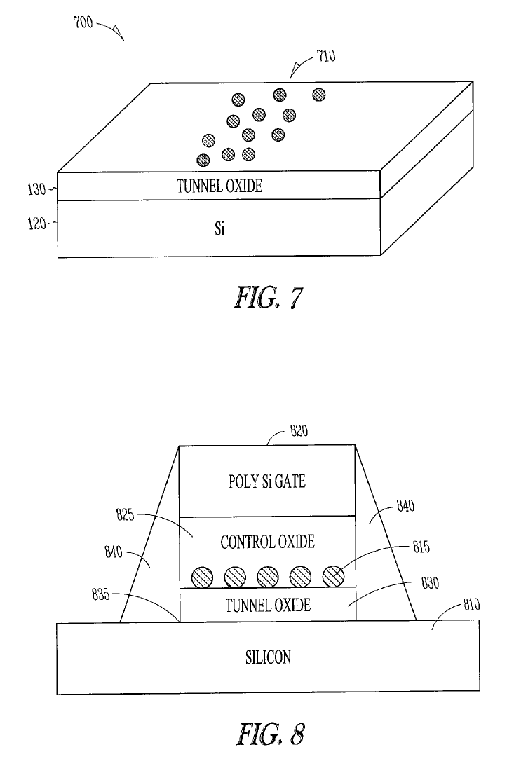

A selective etch may then be performed to remove the metallic nanocrystals 110 that were previously covered and not protected by a protective shell 610. The protective shell 610 prevents the metallic nanocrystals 110 from being removed by the etch. The result is shown in FIG. 7 that illustrates a device 700, where a pattern of metallic nanocrystals with protective shells is illustrated at 710. Solutions used for such selective etch may be adapted to the silanized nature of the metallic nanocrystal, such that unprotected metallic nanocrystals 110 are etched, while those having protective shells 610 are not etched. For example, CARO(H₂SO₄+H₂O₂) may be used for NiSi and Aqua regia (HNO₃+HCl) may be used for PtSi metallic nanocrystals 110.

In one embodiment, the protective shell 610 is formed by exposing the exposed metallic nanocrystals 110 to a silicon precursor gas at a temperature less than approximately 450° C. Further, the protective shell 610 may include a metal oxide, having a metal different than a metal used to form metallic nanocrystals 110.

In various embodiments, mask 210 may be formed of different patterned polymers. Patterning may be performed by many different methods, such as e-beam lithography. Auto-organized polymers may be used in further embodiments. In yet further embodiments, hard masks may be deposited at low temperatures, such as less than approximately 450° C. The type of hard mask may be chosen to be non destructive for metallic nanocrystals 110.

In some embodiments, the metals used for the metallic nanocrystals 110 are nobler than silicon or other material used to form the protective shell 610. This facilitates the oxidation of silicided nanocrystals, leading to formation of the protective shell 610. In further embodiments, protection of the metallic nanocrystals 110 may be provided by other dielectric materials, such as nitrides or silicon with nitride for example.

In one embodiment illustrated in block cross section form in FIG. 8, a device comprises silicon substrate 810 and a patterned plurality of metallic nanocrystals 815 supported by the substrate 810. In one embodiment, the metallic nanocrystals 815 have protective shells which may be formed of oxide. Device 800 may be formed using CMOS processing technology. The patterned plurality of metallic nanocrystals 815 comprises a charge storage area for a memory device in one embodiment. A gate 820 is separated from the patterned plurality of metallic nanoparticles by an electrically insulating layer 825, also referred to as a control oxide, having an electrical equivalent oxide (EOT) thickness in the 1-20 nm range in one embodiment. For example, in the case of high temperature oxidation (HTO), the thickness of insulating layer 825 could be in the range 8-12 nm. The thickness of insulating layer 825 may be varied significantly in further embodiments consistent with desired operation of the device. Insulating layer 825 may be formed of a dielectric material such as SiO₂, HfAlO, HfO₂, ONO, SiON or an oxide in various embodiments.

The formation of the insulating layer 825 may be performed at a high temperature, in the 150-950° C. range and (greater than 700° C. for HTO oxide deposition), and may also include oxidant precursors. The formation of the insulating layer 825 may require thermal conditions and the use of oxidant precursors which are not compatible with stability of high density and small size unprotected metallic nanocrystals 615. Without the process of embodiments of the invention, such temperatures may adversely affect non-encapsulated metallic nanocrystals, and may cause coalescence of the metallic nanocrystals 110, degrading their ability to hold a charge. When using the process of embodiments of the invention, such a temperature results in an oxide that helps maintain overall device integrity and performance characteristics. The protective shells 610 serve to ensure that the metallic nanocrystals 815 maintain their integrity during formation of the insulating layer 825, and function as desired to hold a charge.

A tunnel oxide 830 separates the patterned plurality of metallic nanocrystals 815 from substrate 810, which includes a transistor channel 835 formed in the substrate opposite the tunnel oxide 830, patterned metallic nanocrystals 815 and gate 820 such that a charge on the metallic nanocrystals 815 affects the conductive properties of the transistor channel 835. Tunnel oxide 830 may have an equivalent oxide thickness in the 1-10 nm range in one embodiment and may be varied significantly in further embodiments. Typical materials for tunnel oxide 830 include but are not limited to SiO₂, SiON, HfAlO, and HfO₂. Other materials may also be used. Spacers 840 such as nitride or other electrically insulating material may be formed on the sides of the stack of layers supported by the substrate 810.

In one method of forming a device that includes metallic nanocrystals 815, the passivation of the metallic nanocrystals 815 before deposition of a control dielectric such as insulating layer 825 helps block metallic nanocrystal 815 diffusion on the tunnel oxide 830 surface. The passivation in one embodiment begins with a selective deposition of silicon on the metallic nanocrystals 815. The deposition method may be a chemical vapor deposition with a silicon precursor such as silane (SiH₄), disilane (Si₂H₆), trisilane (Si₃H₈) or other gaseous precursor of silicon. The temperature of the deposition may be selected to avoid diffusion of metal on the tunnel oxide 830 surface and to allow catalytic reaction between the Silicon precursor and the metal. It may also be a compromise between temperature and pressure. One such temperature range may be above 25° C. and less than approximately 450° C. for SiH₄ used on Pt metallic nanocrystals 815.

In one embodiment, selective silicon deposition is performed on the metallic nanocrystals 815 without inter-diffusion between metal and silicon. In a further embodiment, a selective silanization of the metallic nanocrystals 815 results in the formation of a metal-Si compound by reaction between the silicon of the gaseous precursor and the metal of the nanocrystals.

Next, a selective oxidation of the silicon part present on the metallic nanocrystals 815 encapsulates the metallic nanocrystals 815 in a protective shell 610 of oxide. The selective oxidation occurs when the metal of the metallic nanocrystals 815 is nobler than the material to be oxidized to form the protective shell 610. In the case of silicon, a silicon oxide protective shell 610 is formed and may be thermodynamically stable around the metallic nanocrystals 815.

Several different oxidation processes may be used, such as natural air oxidation, an annealing under an oxidant atmosphere such as O₂, NO₂, NO, etc., or a chemical oxidation using an oxidant liquid solution that is aqueous or organic. At this point, the metallic nanocrystals 815 are passivated and ready to be encapsulated with a control dielectric such as insulating layer 825. The insulating layer 825 may be deposited at high temperature to form a high quality control oxide. In various embodiments, the temperature used for dielectric process may range from 150 to 900° C. For HTO, the temperature may be around or above 700° C.

In a further embodiment, a metal for the metallic nanocrystals 815 is selected that oxidizes in ambient air (especially Ni). This leads to ensuring that no exposure to ambient air is allowed between the metallic nanocrystal 815 formation and the beginning of silanization or passivation. In a further embodiment, the metallic nanocrystals 815 may be formed with several different metal alloys, such as PtNi. In such a case, the metallic nanocrystal 815 is formed with a core of one metal such as Pt, and is then surrounded by a shell of an oxide 610 of the second metal, such as NiO.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
forming a mask on a substrate supporting a plurality of metallic nanocrystals such that a portion of the plurality of metallic nanocrystals is exposed;
forming protective shells about the exposed metallic nanocrystals; and
removing the metallic nanocrystals without protective shells.

2. The method of claim 1 wherein the mask comprises a resist.

3. The method of claim 1 wherein the protective shells comprise SiO₂.

4. The method of claim 3 wherein the metallic nanocrystals comprise a metal nobler than silicon.

5. The method of claim 1 wherein the metallic nanocrystals are selected from the group consisting of Ni, Pt, Ag, and W.

6. The method of claim 1 wherein forming protective shells comprises silanizing the exposed metallic nanocrystals and exposing the silanized metallic nanocrystals to an oxidant atmosphere.

7. The method of claim 1 wherein forming protective shells comprises exposing the exposed metallic nanocrystals to a silicon precursor gas at a temperature less than approximately 450° C.

8. The method of claim 1 wherein a protective shell comprises a metal oxide having a metal different than a core metal of a metallic nanocrystal.

9. A method comprising:
forming a plurality of metallic nanocrystals supported by a tunnel oxide that is supported by a substrate;
forming a mask supported by the substrate such that a portion of the plurality of metallic nanocrystals is exposed and other metallic nanocrystals are covered by the mask;
forming protective shells about the exposed metallic nanocrystals, removing the mask and selectively etching to remove the metallic nanocrystals that were previously covered by the mask.

10. The method of claim 9 wherein the mask comprises a patterned polymer.

11. The method of claim 9 wherein the protective shells comprise SiO₂.

12. The method of claim 11 wherein the metallic nanocrystals comprise a metal nobler than silicon.

13. The method of claim 9 wherein the metallic nanocrystals are selected from the group consisting of Ni, Pt, Ag, and W.

14. The method of claim 9 wherein forming protective shells comprises silanizing the exposed metallic nanocrystals and exposing the silanized metallic nanocrystals to an oxidant atmosphere.

15. The method of claim 9 wherein the protective shell comprises a metal oxide having a metal different than a core metal of the metallic nanoparticle.

16. A device comprising:
a substrate and
a patterned plurality of metallic nanoparticles supported by the substrate, the metallic nanocrystals having protective oxide shells.

17. The device of claim 16 wherein the protective oxide shells comprise SiO₂.

18. The device of claim 16 wherein the patterned plurality of nanocrystals comprises a charge storage area for a memory device.

19. The device of claim 16 and further comprising:
a gate separated from the patterned plurality of metallic nanocrystals by an electrically insulating layer,
a tunnel oxide and
a transistor channel opposite the tunnel oxide, patterned metallic nanocrystals and gate such that a charge on the metallic nanocrystals affects the conductive properties of the transistor channel.
